(19) United States
(12) Patent Application Publication
(10) Pub. No.: US 2026/0302300 A1
(43) Pub. Date: Oct. 1, 2026

(54) COMPOSITE ION-CONDUCTING MEMBRANE

(71) Applicant: JOHNSON MATTHEY HYDROGEN TECHNOLOGIES LIMITED, LONDON (GB)

(72) Inventors: Dharshini Chryshantha FONGALLAND, Reading (GB); Melissa Hoang Lan NOVY, Reading (GB); Michael Ian PETCH, Swindon (GB); Jhonny Albino RODRIGUES RAMOS, Reading (GB); Michael Andrew YANDRASITS, Reading (GB)

(21) Appl. No.: 19/479,624

(22) PCT Filed: Jun. 28, 2024
(86) PCT No.: PCT/GB2024/051673

§ 371 Date: Oct. 28, 2025

(30) Foreign Application Priority Data
Jun. 28, 2023 (GB) 2309718.1
Jan. 12, 2024 (GB) 2400459.0

(51) Int. Cl. H01M 8/1039; C08J 5/22; C25B 9/23; C25B 13/08; H01M 8/1004; H01M 8/1032; H01M 8/1053

(52) U.S. Cl. CPC H01M 8/1039; C08J 5/2237; C08J 5/2256; C08J 5/2275; C08J 5/2281; C25B 9/23; C25B 13/08; H01M 8/1004; H01M 8/1032; H01M 8/1053; C08J 2327/12; C08J 2379/04; H01M 2300/0082; H01M 2300/0094

(57) ABSTRACT

The present invention provides an ion-conducting membrane and its method of manufacture, the membrane comprising: ⋅(a) an ion-conducting polymer; and ⋅(b) particles of a non-ionically conducting heterocyclic-based polymer comprising basic functional groups.

### FIELD OF THE INVENTION

This invention relates to ion-conducting membranes containing additives which reduce degradation pathways. In particular, this invention relates to proton exchange membranes, and methods of manufacturing the same. The ion-conducting membranes can be suitable for use in electrochemical devices such as fuel cells and/or electrolysers.

### BACKGROUND OF THE INVENTION

A fuel cell is an electrochemical cell comprising two electrodes separated by an electrolyte. A fuel, e.g. hydrogen, an alcohol such as methanol or ethanol, or formic acid, is supplied to the anode and an oxidant, e.g. oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

Fuel cells are usually classified according to the nature of the electrolyte employed. Often the electrolyte is a solid polymeric membrane, in which the membrane is electronically insulating but ionically conducting. In the proton exchange membrane fuel cell (PEMFC) the membrane is proton conducting, and protons, produced at the anode, are transported across the membrane to the cathode, where they combine with oxygen to form water.

An electrolyser is an electrochemical device for electrolysing water to produce high purity hydrogen and oxygen. Electrolysers can operate in both alkaline and acidic systems. Those electrolysers that employ a solid proton-conducting polymer electrolyte membrane, or proton exchange membrane (PEM), are known as proton exchange membrane water electrolysers (PEMWEs). Those electrolysers that utilise a solid anion-conducting polymer electrolyte membrane, or anion exchange membrane (AEM), are known as anion exchange membrane water electrolysers (AEMWEs).

Conventional ion-conducting membranes used in PEMFCs or PEMWEs are generally formed from sulfonated fully-fluorinated polymeric materials (often generically referred to as perfluorinated sulphonic acid (PFSA) ionomers). As an alternative to PFSA type ionomers, it is possible to use ion-conducting membranes based on partially-fluorinated or non-fluorinated hydrocarbon sulfonated or phosphonated polymers.

In fuel cells and electrolysers, radicals can form in the ion-conducting membrane for example from the breakdown of hydrogen peroxide which can be a bi-product formed during operation. Such radicals can break down the ion-conducting membrane and reduce durability. Such breakdown of the ion-conducting membrane has been conventionally restricted by the inclusion of a radical scavenger, for example ceria-based materials as disclosed, for example, in WO2007/120190 to 3M Innovative Properties Co. Ways of improving the durability of ion-conducting membranes by stopping the action of radicals are desired, especially if metal cations or oxides are not required.

There is also a desire for ion-conducting membranes with high mechanical durability. It is desirable for ion-conducting membranes to be strong in the sense that they are resistant to deformation in real world use where the membranes can be subject to extremes of humidity and temperature and pressure which can cause deformation and ultimately failure of the membrane.

### SUMMARY OF THE INVENTION

Accordingly, provided herein is an ion-conducting membrane comprising:
(a) an ion-conducting polymer; and
(b) particles of a non-ionically conducting heterocyclic-based polymer comprising basic functional groups.

The ion-conducting membrane suitably has a peak tan δ which is greater than the ion-conducting polymer. The ion-conducting membrane suitably has a peak tan δ which is at least about 10° C. greater than the ion-conducting polymer. The ion-conducting membrane suitably has a peak tan δ at a temperature of greater than about 90° C. The ion-conducting membrane suitably has a peak tan δ at a temperature of greater than about 130° C.

Surprisingly, particles of non-ionically conducting heterocyclic-based polymer comprising basic functional groups exhibit radical inhibition properties.

Surprisingly, particles of non-ionically conducting heterocyclic-based polymer comprising basic functional groups increase the mechanical strength of the ion-conducting membrane such that the membrane exhibits a peak tan δ at a temperature higher than a membrane which does not comprise the particles. A higher peak tan δ means that the ion-conducting membrane can operate at higher temperatures without softening, which can lead to mechanical failure.

Also provided is a process of preparing particles of a non-ionically conducting heterocyclic-based polymer comprising basic functional groups, the process comprising precipitation from solution by a polymer microfluidics process. In particular, the polymer microfluidics process comprises the steps of:
(a) providing a solution of the non-ionically conducting heterocyclic-based polymer comprising basic functional groups dissolved in an organic solvent;
(b) flowing the solution through a nozzle into a capillary in which the particles form by precipitation;
(c) collecting from the capillary a dispersion of particles of the non-ionically conducting heterocyclic-based polymer comprising basic functional groups.

The present inventors have found that the size of particles of the non-ionically conducting heterocyclic-based polymer comprising basic functional groups can be controlled such that overall surface area is maximised and thus the ability of the particles to prevent radical activity is maximised. The ability of the particles to modulate tan δ can also be maximised.

Also provided is a catalyst-coated membrane for a fuel cell or a water electrolyser comprising an ion-conducting membrane according to the disclosure, with a cathode catalyst layer applied to a first face of the membrane and/or an anode catalyst layer applied to a second face of the membrane.

Also provided is a membrane-electrode assembly for a fuel cell or a water electrolyser comprising (i) an ion-conducting membrane according to the disclosure; or (ii) a catalyst-coated membrane according to the disclosure; and at least one of a gas diffusion layer or a porous transport layer.

Also provided is a water electrolyser or a fuel cell comprising a catalyst-coated membrane according to the disclosure or a membrane-electrode assembly according to the disclosure.

Also provided is a process of preparing an ion-conducting membrane according to the disclosure, the process comprising the steps of:
(a) dispersing particles of the non-ionically conducting heterocyclic-based polymer comprising basic functional groups in the ion-conducting polymer;
(b) forming the ion-conducting membrane from the dispersion produced in step (a). The particles of the non-ionically conducting heterocyclic-based polymer comprising basic functional groups may be prepared by the process disclosed herein.

Also provided is use of particles of a non-ionically conducting heterocyclic-based polymer comprising basic functional groups for preventing radical degradation of an ion-conducting membrane.

Also provided is use of particles of a non-ionically conducting heterocyclic-based polymer comprising basic functional groups for increasing the temperature at which an ion-conducting membrane exhibits a peak tan δ. The temperature is suitably increased by at least about 10° C.

Also provided is a method of preventing radical degradation of an ion-conducting membrane, the method comprising using an ion-conducting membrane which comprises particles of a non-ionically conducting heterocyclic-based polymer comprising basic functional groups. The particles prevent radical degradation of the ion-conducting membrane.

Also provided is a method of increasing the temperature at which an ion-conducting membrane exhibits a peak tan δ, the method comprising using an ion-conducting membrane which comprises particles of a non-ionically conducting heterocyclic-based polymer comprising basic functional groups. The particles increase the temperature at which the ion-conducting membrane exhibits peak tan δ. The temperature is suitably increased by at least about 10° C.

### BRIEF DESCRIPTION OF THE DRAWINGS

FIG. 1 provides UV-vis spectra from a radical absorption test using RhB dye before and after the addition of 10 microliters of 3% H₂O₂, with and without the presence of particles used in the present disclosure or ceria particles.

FIG. 2 provides the recovery factor (R) for each additive calculated from the spectra in FIG. 1.

FIG. 3 is a schematic of the microfluidic particle engineering process disclosed herein.

FIG. 4 is an image of a capillary used in the polymer microfluidics process disclosed herein.

FIG. 5 is a graph showing particle size for particles of polybenzimidazole prepared by the process disclosed herein using different flow rates of polybenzimidazole solution.

FIG. 6 is a graph demonstrating the change in tan δ as a function of temperature for an ion-conducting membrane according to the disclosure and a comparative ion-conducting membrane.

### DETAILED DESCRIPTION OF THE INVENTION

The ion-conducting polymer can be a proton-conducting polymer or an anion-conducting polymer, such as a hydroxyl anion-conducting polymer. Preferably a proton-conducting polymer. Typically, the ion-conducting polymer comprises sulfonic acid groups. Suitably, the ion-conducting polymer is a perfluorinated sulfonic acid ionomer, or a partially-fluorinated or non-fluorinated hydrocarbon sulfonic acid ionomer. Examples of suitable proton-conducting polymers include partially- or fully-fluorinated sulphonic acid polymers, such as perfluorosulphonic acid ionomers (e.g. Nafion® (Chemours), Aciplex® (Asahi Kasei), Aquivion™ (Synesqo), Flemion® (Asahi Glass Co.); or ionomers based on a sulphonated hydrocarbon such as those available from FuMA-Tech GmbH as the Fumapem® P, E or K series of products, JSR Corporation, Toyobo Corporation, Toray and others. Examples of suitable anion-conducting polymers include A901 made by Tokuyama Corporation and Fumasep FAA from FuMA-Tech GmbH. Typically, the ion-conducting polymer has an equivalent weight of about 1100 or less, typically about 900 or less, suitably about 850 or less. Typically, the ion-conducting polymer has an equivalent weight of at least about 450. The equivalent weight of the ion-conducting polymer may be readily measured using an acid titration following a hydroxide exchange. For example, a membrane sample may be vacuum dried at about 110° C. for 16 hours to obtain about 2 g of the dried film. The film may then be immersed in about 30 mL of a 0.1N NaOH solution to substitute sodium ions for protons in the membrane. Then titration by neutralisation is carried out, for example using 0.1N hydrochloric acid, to determine the number of exchangeable protons, and therefore the EW may be calculated.

The basic functional groups in the non-ionically conducting heterocyclic-based polymer are typically nitrogen functional groups. Suitably, the basic functional groups are amine functional groups, typically with no α-hydrogen. The non-ionically conducting heterocyclic-based polymer may suitably be selected from polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polybenzoxazoles, polythiazoles, polypyrazoles and derivatives thereof. The non-ionically conducting heterocyclic-based polymer may also be a polyamide-imide. Typically, the non-ionically conducting heterocyclic-based polymer is selected from polybenzimidazoles, polytriazoles, polythiazoles, polydithiazoles and derivatives thereof. More typically, the non-ionically conducting heterocyclic-based polymer is a polybenzimidazole or a derivative thereof. For avoidance of doubt, reference to particles of a non-ionically conducting heterocyclic-based polymer comprising basic functional groups does not include structures fabricated from such particles which may be said to comprise the particles. For example, it does not include nanofibers or woven materials or the like.

The particles are suitably solid and non-porous. That is to say, they are not nanoframes or hollow nanostructures and they do not comprise networks of pores which interconnect throughout the catalyst particles. The particles are suitably spherical. The particles suitably consist of the non-ionically conducting heterocyclic-based polymer. In particular, the particles do not contain any of the ion-conducting polymer. This is because the particles are suitably fabricated, typically by the process disclosed herein, and then mixed with the ion-conducting polymer prior to forming an ion-conducting membrane. There is suitably no chemical bonding between the non-ionically conducting heterocyclic-based polymer and the ion-conducting polymer in the membrane of the present disclosure. For example, there is no covalent or ionic bonding, for example which results from the non-ionically conducting heterocyclic-based polymer and the ion-conducting polymer reacting with each other during membrane fabrication. This does not preclude interaction between the two components in the membrane which is natural between an acidic medium (the ion-conducting polymer) and a basic medium.

The particles may have particle size of about 2 micrometres or less, typically 1 micrometre or less, for example about 500 nm or less, typically about 250 nm or less. The particles may have a particle size of at least about 5 nm, typically at least about 10 nm. Particle size is typically the Zave particle size measured by dynamic light scattering (typically in a Zetasizer from Malvern Panalytical) at an angle of 174 degrees. A solution with a weight percent in the range of and including 0.01 to 0.1% by total weight of the solution may be used. About 1 mL of sample is placed in a glass cuvette and measurements run to give the Zave particle size for 5 measurements.

The particles may have a surface area of no more than 2.5×10⁷ nm², suitably no more than 5×10⁶ nm², suitably no more than 2.5×10⁵ nm². The particles may have a surface area of no less than 50 nm², suitably no less than 250 nm². The surface area may be calculated by methods known in the art from the particle size (diameter) obtained by dynamic light scattering, typically using the dynamic light scattering method described above, assuming a non-porous sphere.

The particles of non-ionically conducting heterocyclic-based polymer may suitably be present in an amount of about 2, suitably about 1 percent by weight or less relative to the total weight of the dry ion-conducting membrane, typically at least about 0.01 percent by weight, for example at least about 0.1 percent by weight. The particles comprise discrete particles, typically dispersed in the ion-conducting membrane. Typically, the particles of non-ionically conducting heterocyclic-based polymer comprising basic functional groups are uniformly distributed across the thickness of the ion-conducting membrane. By “uniform” it is meant that the amount of particles typically does not vary by more than +50%, suitably by more than +20%. The particles may also not be uniformly distributed. For example, there may be a variation in distribution in the z-direction (membrane thickness direction), typically with a greater concentration closer to an anode side of a catalyst-coated membrane comprising the ion-conducting membrane. Typically, the ion-conducting membrane does not comprise a cerium-containing compound or a manganese-containing compound. The ion-conducting membrane may further comprise additives, such as supported or unsupported recombination catalyst particles, for example platinum catalyst particles (optionally on a carbon or metal oxide support).

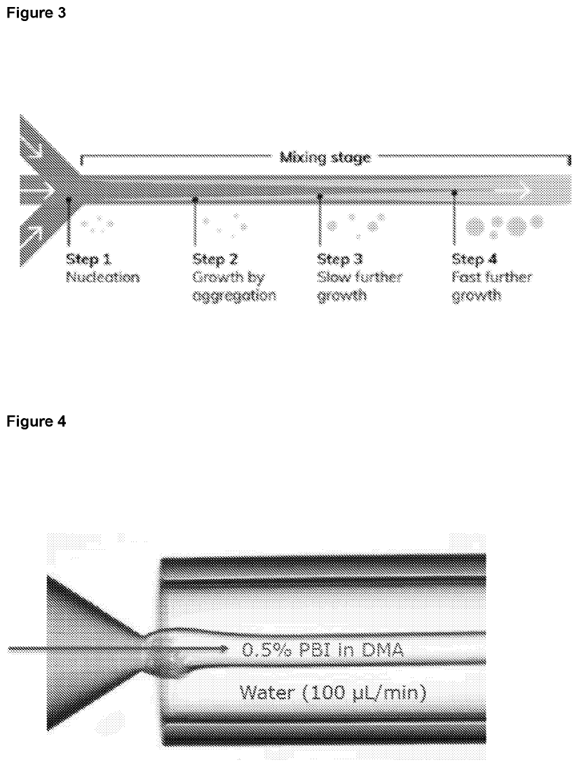

Particles of a non-ionically conducting heterocyclic-based polymer comprising basic functional groups may be prepared by a process comprising precipitation from solution by a polymer microfluidics process. Typically, the polymer microfluidics process comprises the steps of:
(a) providing a solution of the non-ionically conducting heterocyclic-based polymer comprising basic functional groups dissolved in an organic solvent;
(b) flowing the solution through a nozzle into a capillary in which the particles form by precipitation;
(c) collecting from the capillary a dispersion of particles of the non-ionically conducting heterocyclic-based polymer comprising basic functional groups. It is advantageous that such a process can be used to control the particles size of the particles of a non-ionically conducting heterocyclic-based polymer comprising basic functional groups, such that the overall surface area of the particles when included in an ion-conducting membrane is high and the action against radical activity is high. The organic solvent is typically selected from N-methylpyrrolidone (NMP), dimethylformamide (DMF), dimethylacetamide (DMAc) or dimethylsulphoxide (DMSO), suitably DMAc or DMSO, suitably the organic solvent is DMAc. Specific aspects of the capillary can be modified by a skilled person depending on the particle size desired, including nozzle exit diameter, capillary diameter, and capillary length. The solution of the non-ionically conducting heterocyclic-based polymer comprising basic functional groups, as well as the flow rate and flow time, may be suitably ascertained. The particles are typically precipitated by a flow of an anti-solvent, such as water, around the capillary and diffusion of the solvent. Typically, the process is carried out at ambient temperature, for example about 25° C. A schematic view of the process and how particles are formed is provided in FIG. 3, with an image of a capillary in use provided in FIG. 4.

Peak tan δ is the maximum value of tan δ in a plot of tan δ against temperature, for example as shown in FIG. 6. The temperature at which peak tan δ occurs is the temperature above which the ion-conducting membrane softens. The value for ion-conducting membranes according to the present disclosure is higher than conventional ion-conducting membranes. Suitably, the ion-conducting membrane has a peak tan δ which is greater than the ion-conducting polymer, suitably at least about 10° C. greater than the ion-conducting polymer, more suitably at least about 20° C. greater, for example at least about 30° C. greater. The tan δ of the ion-conducting polymer can be determined by casting a membrane consisting of the ion-conducting polymer, i.e. which does not contain particles of the non-ionically conducting heterocyclic-based polymer comprising basic functional groups, or any other additives, and determining peak tan δ for the membrane. Ion-conducting membranes according to the present disclosure have a peak tan δ at a temperature of greater than about 90° C. or greater than about 120° C., typically greater than about 130° C., for example greater than about 140° C. The upper temperature limit for peak tan δ is not particularly limited but may, for example, be at most about 250° C., for example 200° C. A plot of tan δ against temperature is a routine data set which can be readily obtained by a person skilled in the art. For avoidance of doubt, the plot can be obtained by the procedure set out in the Examples section.

The ion-conducting membrane may further comprise: (c) a reinforcing layer comprising a porous polymer material, wherein the ion-conducting polymer is impregnated within the porous polymer material. For avoidance of doubt, the reinforcing layer is a sperate entity from the particles of the non-ionically conducting heterocyclic-based polymer comprising basic functional groups. The reinforcing layer is typically planar. The porous polymer material may be a fluoropolymer. The porous polymer material may be selected from polyvinylidene fluoride (PVDF), polytetrafluoroethylene (PTFE), polyethersulfone (PES), poly(vinylidene fluoride-co-hexafluoropropylene) (PVDF-HFP), polyimides (PI), polyetherimide (PEI), poly(aryl ether ketone) (PAEK), poly(aryl ether sulfone), poly(phenylene sulfide) (PPS) and polyvinylpyrrolidone (PVP). The porous polymer material may be expanded polytetrafluoroethylene (ePTFE). The porous polymer material may also comprise a polymer backbone based on a nitrogen-containing heterocycle. The nitrogen-containing heterocycle may comprise basic functional groups. The nitrogen-containing basic functional groups can be nitrogen with a lone pair. The polymer backbone can be suitably derived from polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polybenzoxazoles, polythiazoles, polypyrazoles, and derivatives thereof. Suitably, the polymer backbone is derived from a functionalised polyazole or a zwitterionic polyazole, such as a polybenzimidazole, polytriazole, polythiazole and polydithiazole and their derivatives; most suitably a polybenzimidazole. It will be understood by the skilled person that the polymer backbone may comprises more than one type of nitrogen-containing heterocycle, or a mixture of a nitrogen-containing heterocycles and other aliphatic or aromatic groups.

Suitably, the porous polymer structure comprises a porous mat of nanofibers. The porous mat is suitably formed from entangled nanofibres. Typically, the nanofibres are ionically non-conductive. For example, the nanofibres are suitably devoid of sulphonic acid groups and/or phosphoric acid groups. The nanofibres may comprise discrete nanofibres that are entwined. For example, the nanofibres can cross each other or be twisted with other nanofibres or itself. The porous mat of nanofibres can be in the form of a non-woven fabric material. Suitably, the nanofibres have a substantially random orientation in the plane of the reinforced ion-conducting membrane (i.e. the xy plane). The nanofibres suitably have a diameter of 50-700 nm, suitably 200-600 nm and preferably 250-550 nm. The length of the nanofibres is not material to the disclosure, but each nanofibre should be sufficiently long (for example several millimetres or centimetres) to be entangled, either with one or more other nanofibres or with itself. The nanofibres are suitably spun nanofibres, i.e. the nanofibres are formed using a spinning technique. Examples of suitable spinning techniques include, but are not limited to, electrospinning and force spinning.

Suitably, the reinforcing layer has a maximum thickness of 100% of the thickness of the reinforced ion-conducting membrane such as a maximum thickness of 90%, 80%, 70%, 60%, or 50% of the thickness of the ion-conducting membrane. The porous polymer material suitably has a minimum thickness of 5% of the thickness of the ion-conducting membrane, such as a minimum thickness of 10%, 15%, 20%, 25% or 30% of the thickness of the ion-conducting membrane. It may be preferred that the porous polymer material in the ion-conducting membrane may have a thickness in the range of and including 5 to 95% of the thickness of the reinforced ion-conducting membrane, such as a thickness in the range of and including 10 to 90% or 20 to 80% of the thickness of the reinforced ion-conducting membrane.

The ion-conducting membrane may contain more than one, for example two, reinforcing layer(s) each having ion-conducting polymer impregnated in at least a region thereof. It will be understood that, in the case that the reinforced ion-conducting membrane has more than one reinforcing layer the maximum and/or minimum thickness is the sum of the thickness of each porous polymer structure. The thickness of the or each porous polymer structure, as a proportion of the reinforced ion-conducting membrane may be determined, for example, from a scanning electron microscope (SEM) image of a cross section of the reinforced ion-conducting membrane.

The thickness of the ion-conducting membrane will depend on its intended use. For example, an ion-conducting membrane for a water electrolyser will typically be thicker than for a fuel cell but that may not always be the case. Suitably, the ion-conducting membrane has a thickness at 0% relative humidity of at least about 5 micrometres. It may be preferred that the ion-conducting membrane has a thickness of at least about 6 micrometres, about 7 micrometres, about 8 micrometres, about 9 micrometres or at least about 10 micrometres. Typically, the thickness of the ion-conducting membrane at 0% relative humidity is less than or equal to about 200 micrometres, such as less than or equal to about 150 micrometres, less than or equal to about 100 micrometres, less than or equal to about 50 micrometres, less than or equal to about 30 micrometres, less than or equal to about 25 micrometres, or less than or equal to about 20 micrometres. The thickness of the membrane may be determined by analysis of a scanning electron microscope (SEM) image of a cross section of the membrane. It may be preferred that the ion-conducting membrane has a thickness at 0% relative humidity in the range of and including about 5 micrometres to about 200 micrometres, about 6 to about 100 micrometres, about 6 to about 50 micrometres, about 7 to about 30 micrometres, or about 8 to about 20 micrometres.

The ion-conducting membrane may be prepared by a process comprising the steps of:
(a) dispersing particles of the non-ionically conducting heterocyclic-based polymer comprising basic functional groups in the ion-conducting polymer;
(b) forming the ion-conducting membrane from the dispersion produced in step (a). Typically, in step (a) the ion-conducting polymer is in a suspension or a solution in a diluent and step (b) comprises forming the ion-conducting membrane from the suspension. The diluent typically comprises an organic solvent, suitably a protic solvent, typically an alcohol solvent. The diluent may also comprise water, and may be a combination of an alcohol and water. In step (a) the particles of the non-ionically conducting heterocyclic-based polymer are typically provided as a dispersion, not a solution, in a polar organic solvent, which may be in combination with water. The polar organic solvent may be an aprotic solvent, for example N, N-dimethylformamide, N, N-dimethylacetamide, N-methylpyrrolidone, dimethylsulfoxide, acetone and methyl ethyl ketone. Any suitable method of formation may be used including, for example spraying, electro-spraying, screen printing, rotary screen printing, inkjet printing, brush coating, painting, immersion or dipping, bar coating, pad coating, gravure; gap coating techniques such as knife or doctor blade over roll (whereby the coating is applied to the substrate then passes through a split between the knife and a support roller); slot die (slot, extrusion) coating (whereby the coating is squeezed out by gravity or under pressure via a slot onto the substrate); metering rod application such as with a Meyer bar and gravure coating. Prior to step (a), the particles of the non-ionically conducting heterocyclic-based polymer comprising basic functional groups may be prepared by the process disclosed herein. In step (c), the ion-conducting membrane may be formed on a substrate, for example a decal backing layer. Alternatively, the ion-conducting membrane may be formed on a fuel cell or electrolyser catalyst layer, typically as part of an additive layer manufacturing approach to manufacturing a fuel cell or electrolyser catalyst-coated membrane.

Also provided is a catalyst-coated membrane comprising an ion-conducting membrane of the disclosure, with a cathode catalyst layer applied to a first face of the membrane and/or an anode catalyst layer applied to a second face of the membrane.

The catalyst layer comprises one or more electrocatalysts. The one or more electrocatalysts may be independently a finely divided unsupported metal powder, or a supported catalyst wherein small nanoparticles are dispersed on electrically conducting particulate carbon supports. The electrocatalyst metal is suitably selected from
(i) the platinum group metals (platinum, palladium, rhodium, ruthenium, iridium and osmium),
(ii) gold or silver,
(iii) a base metal,
or an alloy or mixture comprising one or more of these metals or their oxides.

The preferred electrocatalyst metal is platinum, which may be alloyed with other precious metals or base metals. A base metal is tin or a transition metal which is not a noble metal. A noble metal is a platinum group metal (platinum, palladium, rhodium, ruthenium, iridium or osmium), gold or silver. Suitable base metals include copper, cobalt, nickel, zinc, iron, titanium, molybdenum, vanadium, manganese, niobium, tantalum, chromium and tin. Preferred base metals are nickel, copper, cobalt, and chromium. More preferred base metals are nickel, cobalt and copper. If the electrocatalyst is a supported catalyst, the loading of metal particles on the carbon support material is suitably in the range 10-90 wt %, preferably 15-75 wt % of the weight of resulting electrocatalyst. The exact electrocatalyst used will depend on the reaction it is intended to catalyse and its selection is within the capability of the skilled person.

The catalyst layer may further comprise additional components. Such additional components include, but are not limited to, a catalyst which facilitates oxygen evolution and therefore will be of benefit in cell reversal situations and high potential excursions, or a hydrogen peroxide decomposition catalyst. Examples of such catalysts and any other additives suitable for inclusion in the catalyst layer will be known to those skilled in the art.

Also provided is a membrane electrode assembly comprising an ion-conducting membrane of the disclosure and a gas diffusion electrode and/or a porous transport layer on a first and/or second face of the ion-conducting membrane. Also provided is a membrane electrode assembly comprising a catalyst-coated ion-conducting membrane and a gas diffusion layer or porous transport layer present on the at least one of the catalyst layers. The anode and cathode gas diffusion layers are suitably based on conventional gas diffusion substrates. Typical substrates include non-woven papers or webs comprising a network of carbon fibres and a thermoset resin binder (e.g. the TGP-H series of carbon fibre paper available from Toray Industries Inc., Japan or the H2315 series available from Freudenberg FCCT KG, Germany, or the Sigracet® series available from SGL Technologies GmbH, Germany or AvCarb® series from Ballard Power Systems Inc., or woven carbon cloths. The carbon paper, web or cloth may be provided with a further treatment prior to being incorporated into a MEA either to make it more wettable (hydrophilic) or more wet-proofed (hydrophobic). The nature of any treatments will depend on the type of fuel cell and the operating conditions that will be used. The substrate can be made more wettable by incorporation of materials such as amorphous carbon blacks via impregnation from liquid suspensions, or can be made more hydrophobic by impregnating the pore structure of the substrate with a colloidal suspension of a polymer such as PTFE or polyfluoroethylenepropylene (FEP), followed by drying and heating above the melting point of the polymer. For applications such as the PEMFC, a microporous layer may also be applied to the gas diffusion substrate on the face that will contact the catalyst layer. The microporous layer typically comprises a mixture of a carbon black and a polymer such as polytetrafluoroethylene (PTFE). The porous transport layer is suitably based on conventional porous transport substrates, such as a titanium mesh.

Also provided is an electrochemical device comprising an ion-conducting membrane, a catalyst-coated membrane, or a membrane-electrode assembly of the disclosure. The electrochemical device can be a fuel cell, such as a proton exchange membrane fuel cell. The electrochemical device can be an electrolyser, such as a water electrolyser.

Also provided is use of particles of a non-ionically conducting heterocyclic-based polymer comprising basic functional groups for preventing radical degradation of an ion-conducting membrane. The ion-conducting membrane is as defined herein and can be used and incorporated into components as described herein. The particles of a non-ionically conducting heterocyclic-based polymer comprising basic functional groups are as defined herein.

Also provided is a method of preventing radical degradation of an ion-conducting membrane, the method comprising using an ion-conducting membrane which comprises particles of a non-ionically conducting heterocyclic-based polymer comprising basic functional groups. The particles prevent radical degradation of the ion-conducting membrane. The ion-conducting membrane is as defined herein and can be used and incorporated into components as described herein. The particles of a non-ionically conducting heterocyclic-based polymer comprising basic functional groups are as defined herein.

### EXAMPLES

Particles of polybenzimidazole (PBI) were prepared by polymer microfluidics with a single nozzle of 90 micrometres to make sub-100 nm particles of PBI by fast nucleation due to solvent diffusion of dimethylacetamide (DMA) driving the nanoprecipitation of insoluble polymer in water. A commercial RayDrop™ by Fluigent with this nozzle aligned to a capillary of 450 micrometres was used with starting polymer concentration of 0.5 wt. % PBI in solvent DMA at various flow rates from 5 to 20 microlitres/min against constant water rate of 100 microlitres/min. Typically each sample was collected after 60 minutes. An example capillary is shown in FIG. 4.

Particle size was measured by dynamic light scattering (Zetasizer) at an angle of 174 degrees. In this case, no dilution was required to run the measurements. Around 1 mL of sample was placed in a glass cuvette to run experiments and average size known as Zave and polydispersity index (PDI) are given for 5 measurements.

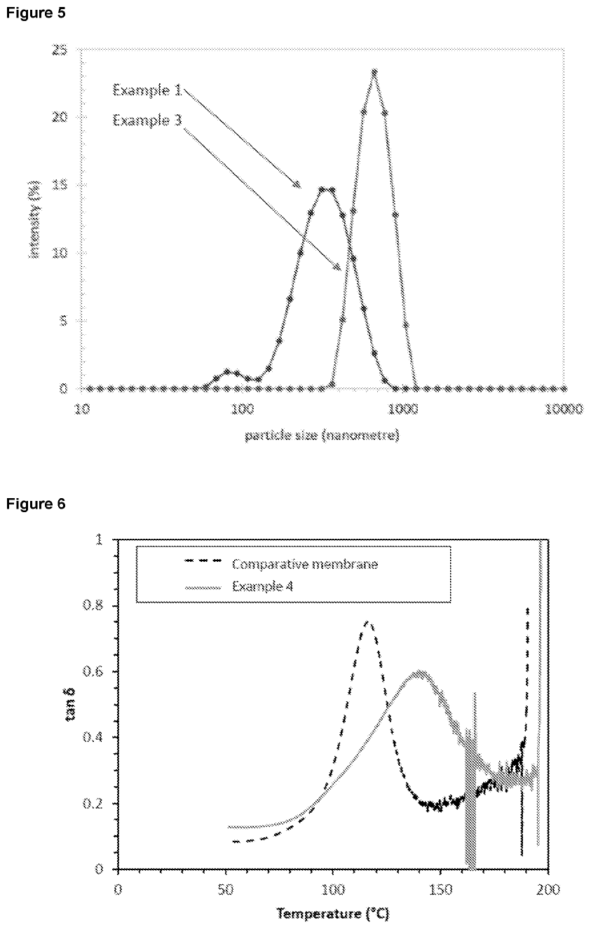

The following examples were prepared, with a graph of particle size v intensity for Examples 1 and 3 shown in FIG. 5.

TABLE 1

| | PBI/DMA | Water | Particle | |
|---|---|---|---|---|
| | microL/min | microL/min | size Zave nm | PDI |
| Example 1 | 5 | 100 | 332 | 0.357 |
| Example 2 | 10 | 100 | 627 | 0.653 |
| Example 3 | 20 | 100 | 1509 | 0.923 |

It can be seen from this data that the particle size of the PBI particles can be carefully controlled by controlling the conditions of the synthesis. This is beneficial, because particles can be synthesised for maximum activity in protecting a membrane from radical activity.

The particles prepared by the method above were subjected to a test for their ability to stop radical action, alongside ceria. The particles were present at 0.3 ppm in the test, and ceria was present at 20 ppm in the test.

The experimental procedure follows that of Fei et al: Fei Yu, Da Xu, Rong Lei, Na Li, and Ke'an Li, Journal of Agricultural and Food Chemistry, 2008, 56, 730-735; and Mei-Fang et al: Mei-Fang Hou, Lin Liao, Wei-De Zhang, Xiao-Yan Tang, Hong-Fu Wan, and Guang-Cai Yin, Chemosphere, 2011, 83, 9, 1279-1283 where the Fenton reaction:

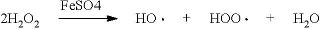

is utilised to create radical species which degrade rhodamine B (RhB) dye. This degradation is followed using UV-vis spectroscopy to ascertain if the presence of different additives can prevent this degradation from happening by means of a radical inhibition mechanism. For UV-vis spectroscopy, Agilent's Cary 5000 UV-vis-NIR was used utilising 1 cm QS cuvettes. The abs peak at 554 nm is followed. To mimic the low pH environment created in a fuel cell from the PFSA ionomer, our tests were done in 1M H₂SO₄. Each test was conducted at the following concentrations of each chemical:
14 ppm RhB
35 ppm Fe²⁺
10 microlitres of 3% H₂O₂ were added and left to mix for 10 minutes before measuring the UV-vis spectra

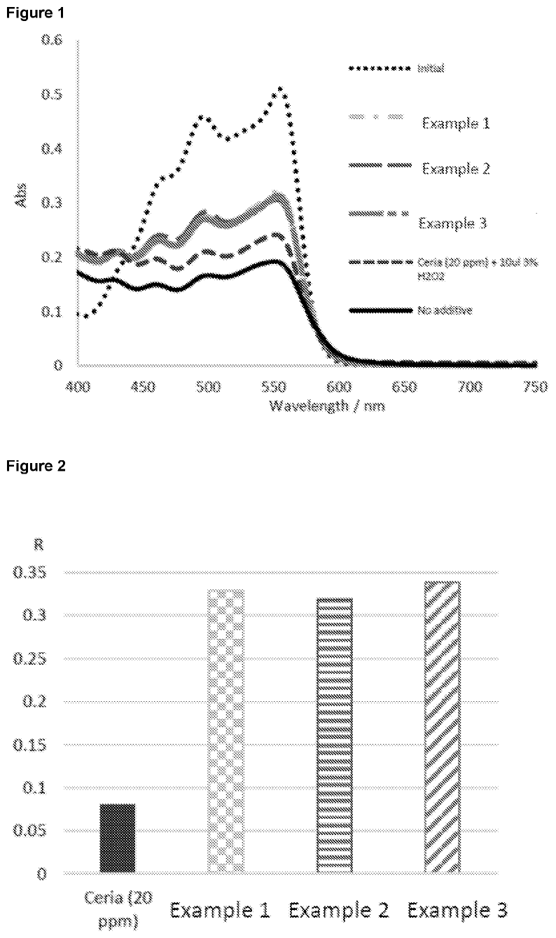

FIG. 1 shows that the presence of the particles of PBI protects the dye from radical degradation better than the known and widely used radical inhibitor ceria. This is evident from the smaller drop in the absorption value at 554 nm with PBI (yellow, pink and green) compared with the drop seen for ceria (blue, dashed line) compared with the initial (black, dotted line).

FIG. 2 shows the recovery factor (R) for each additive calculated from the spectra in FIG. 1 via the equation

$$R = 1 - \frac{ΔAbs ( F R S )}{ΔAbs ( R h B )} .$$

Even at orders of magnitude lower concentrations of additive (0.3 v 20 ppm), the PBI is superior at protecting the dye from radical degradation.

An ion-conducting membrane containing particles of PBI is prepared by slowly adding a concentrated PBI dispersion into a dispersion of PFSA while continuously stirring to achieve a desired PBI: PFSA ratio. This dispersion is then cast using a knife coater onto backing material and dried into a membrane. The membrane and catalyst layers are hot pressed to form a catalyst-coated membrane by standard techniques.

### Example 4

A comparative ion-conducting membrane which does not contain particles of PBI was prepared by casting a mixed alcohol-water dispersion of 800 EW PFSA onto a backing material using a knife coater, before drying the dispersion to form a membrane.

An ion-conducting membrane, Example 4, containing particles of PBI as prepared in Example 3 at 1 wt % PBI particles by total weight of the ion-ducting membrane was prepared by slowly adding a dispersion of PBI nanoparticles in 90/10 w/w water/DMF to a dispersion of 800 EW PFSA in mixed alcohol-water to achieve the correct ratio of PFSA to PBI. The mixture of PFSA and PBI was sonicated at room temperature for 30 min to disperse the PBI nanoparticles. Then, this mixture was cast onto a substrate using knife coating and the solvent was evaporated to form a membrane.

A plot of tan δ against temperature for Example 4 and the comparative ion-conducting membrane is shown in FIG. 6. It can be seen that peak tan δ occurs at a higher temperature for Example 4, about 25° C. higher, which means that the ion-conducting membrane can operate at higher temperatures without softening, which softening can lead to mechanical failure. To generate a plot of tan δ against temperature, firstly a TA Instruments DMA 850 with tensile film clamp was used to obtain dynamic mechanical analysis measurements. Approximately 7 mm wide strips of membrane were cut and clamped into the tensile film clamp using 3 inch pounds of torque and with a gauge length of approximately 7 mm. The temperature was ramped from room temperature to 200° C. at 2° C./min, while an oscillatory tensile displacement of 20 μm and 1 Hz was applied to the membrane. The storage and loss moduli of the membrane were recorded as a function of temperature. Tan δ was calculated as the ratio of the loss modulus to the storage modulus.

1. An ion-conducting membrane comprising:
(a) an ion-conducting polymer; and
(b) particles of a non-ionically conducting heterocyclic-based polymer comprising basic functional groups.

2. An ion-conducting membrane according to claim 1, wherein the ion-conducting membrane has a peak tan δ which is greater than the ion-conducting polymer.

3. An ion-conducting membrane according to claim 1, wherein the ion-conducting membrane has a peak tan δ which is at least about 10° C. greater than the ion-conducting polymer.

4. An ion-conducting membrane according to claim 1 or claim 2 or claim 3, wherein the ion-conducting membrane has a peak tan δ at a temperature of greater than about 120° C.

5. An ion-conducting membrane according to any one of the preceding claims, wherein the ion-conducting polymer is a proton conducting polymer.

6. An ion-conducting membrane according to any one of the preceding claims, wherein the proton conducting polymer is a perfluorinated sulfonic acid ionomer.

7. An ion-conducting membrane according to any one of the preceding claims, wherein the non-ionically conducting heterocyclic-based polymer is selected from polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polybenzoxazoles, polythiazoles, polypyrazoles and derivatives thereof.

8. An ion-conducting membrane according to any one of the preceding claims, further comprising:
(c) a reinforcing layer comprising a porous polymer material, wherein the ion-conducting polymer is impregnated within the porous polymer material.

9. An ion-conducting membrane according to claim 8, wherein the reinforcing layer comprises a porous mat of nanofibers.

10. An ion-conducting membrane according to claim 9, wherein the nanofibres are composed of a non-ionically conducting heterocyclic-based polymer.

11. An ion-conducting membrane according to claim 10, wherein the reinforcing layer comprises a planar porous polymer material which is a fluoropolymer.

12. A catalyst-coated membrane for a fuel cell or a water electrolyser comprising an ion-conducting membrane according to any one of claims 1 to 11, with a cathode catalyst layer applied to a first face of the membrane and/or an anode catalyst layer applied to a second face of the membrane.

13. A membrane-electrode assembly for a fuel cell or a water electrolyser comprising (i) an ion-conducting membrane according to any one of claims 1 to 11; or (ii) a catalyst-coated membrane according to claim 12; and at least one of a gas diffusion layer or a porous transport layer.

14. A water electrolyser or a fuel cell comprising a catalyst-coated membrane according to claim 11 or a membrane-electrode assembly according to claim 13.

15. Use of particles of a non-ionically conducting heterocyclic-based polymer comprising basic functional groups for preventing radical degradation of an ion-conducting membrane.

16. A method of preventing radical degradation of an ion-conducting membrane, the method comprising using an ion-conducting membrane which comprises particles of a non-ionically conducting heterocyclic-based polymer comprising basic functional groups.

17. A process of preparing particles of a non-ionically conducting heterocyclic-based polymer comprising basic functional groups, the process comprising precipitation from solution by a polymer microfluidics process.

18. A process according to claim 16, wherein the polymer microfluidics process comprises the steps of:
(a) providing a solution of the non-ionically conducting heterocyclic-based polymer comprising basic functional groups dissolved in an organic solvent;
(b) flowing the solution through a nozzle into a capillary in which the particles form by precipitation;
(c) collecting from the capillary a dispersion of particles of the non-ionically conducting heterocyclic-based polymer comprising basic functional groups.

19. A process of preparing an ion-conducting membrane as defined in any one of claims 1 to 11, the process comprising the steps of:
(a) dispersing particles of the non-ionically conducting heterocyclic-based polymer comprising basic functional groups in the ion-conducting polymer;
(b) forming the ion-conducting membrane from the dispersion produced in step (a).

20. A process according to claim 19, wherein in step (a) the ion-conducting polymer is in a suspension in a diluent and step (b) comprises forming the ion-conducting membrane from the diluent.

21. A process according to claim 19 or claim 20, wherein the particles of the non-ionically conducting heterocyclic-based polymer comprising basic functional groups are prepared by a process as defined in claim 17 or claim 18.

22. Use of particles of a non-ionically conducting heterocyclic-based polymer comprising basic functional groups for increasing the temperature at which an ion-conducting membrane exhibits a peak tan δ.

23. A method of increasing the temperature at which an ion-conducting membrane exhibits a peak tan δ, the method comprising using an ion-conducting membrane which comprises particles of a non-ionically conducting heterocyclic-based polymer comprising basic functional groups.
